(19) United States
(12) Patent Application Publication
(10) Pub. No.: US 2014/0101732 A1
(43) Pub. Date: Apr. 10, 2014

(54) Communication with a Voice-Based Account Management System

(71) Applicant: Bank of America Corporation, Charlotte, NC (US)

(72) Inventor: Matthew Brian Cincera, Charlotte, NC (US)

(73) Assignee: Bank of America Corporation, Charlotte, NC (US)

(21) Appl. No.: 13/646,777

(22) Filed: Oct. 8, 2012

(51) Int. Cl. G06F 21/20

(52) U.S. Cl. 726/5

(57) ABSTRACT

According to an embodiment, a method facilitates communication with a voice-based management system. An authentication credential is received. Based on the authentication credential, a user is allowed to access an on-line management system operable to facilitate management of an account. The on-line management system receives a request to connect the user to a voice-based management system operable to facilitate providing a response to a question included in the request. A user type associated with the user is determined. A context associated with the question included in the request is determined. A response unit in the voice-based management system is determined according to the user type and the context. The user is connected to the response unit in the voice-based management system without requiring the user to provide the authentication credential to the response unit.

### TECHNICAL FIELD OF THE INVENTION

This invention relates, in general, to account management and, more particularly, to communication with a voice-based account management system.

### BACKGROUND OF THE INVENTION

A user may have one or more accounts offered from an enterprise. The enterprise may offer various services related to the accounts and provide information related to the accounts. Users may have multiple ways in which to access this information. At times, a user may not have enough information from which to make decisions regarding the various optional services related to the accounts.

### SUMMARY OF THE INVENTION

In accordance with the present invention, disadvantages and problems associated with account management may be reduced or eliminated.

According to one embodiment of the present invention, a method facilitates communication with a voice-based management system. An authentication credential is received. Based on the authentication credential, a user is allowed to access an on-line management system operable to facilitate management of an account. The on-line management system receives a request to connect the user to a voice-based management system operable to facilitate providing a response to a question included in the request. A user type associated with the user is determined. A context associated with the question included in the request is determined. A response unit in the voice-based management system is determined according to the user type and the context. The user is connected to the response unit in the voice-based management system without requiring the user to provide the authentication credential to the response unit.

Certain embodiments of the invention may provide one or more technical advantages. A technical advantage of one embodiment allows a user to be authenticated to a voice-based management system automatically from within an on-line account management system. The user may not have to go through additional validation/authentication steps when connecting to the voice-based management system. Another technical advantage of an embodiment allows the user to submit a question through a graphical user interface of an on-line account management system. Information about the question and the user may be routed to a suitable response unit with minimum reproduction of the same input provided by the user. This may reduce the amount of time the user spends overall attempting to get an answer to a question. The overall time spent may be reduced even further if the user originally would have been routed to several different response units in order to have a question answered suitably, each time requiring user validation/authentication.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system operable to facilitate communication with a voice-based management system.

FIG. 2 illustrates an example graphical user interface operable to allow a user to submit a question regarding a prior transaction to a voice-based management system from within an on-line account management system.

FIG. 3 illustrates an example flow chart for facilitating communication with a voice-based management system.

### DETAILED DESCRIPTION OF THE INVENTION

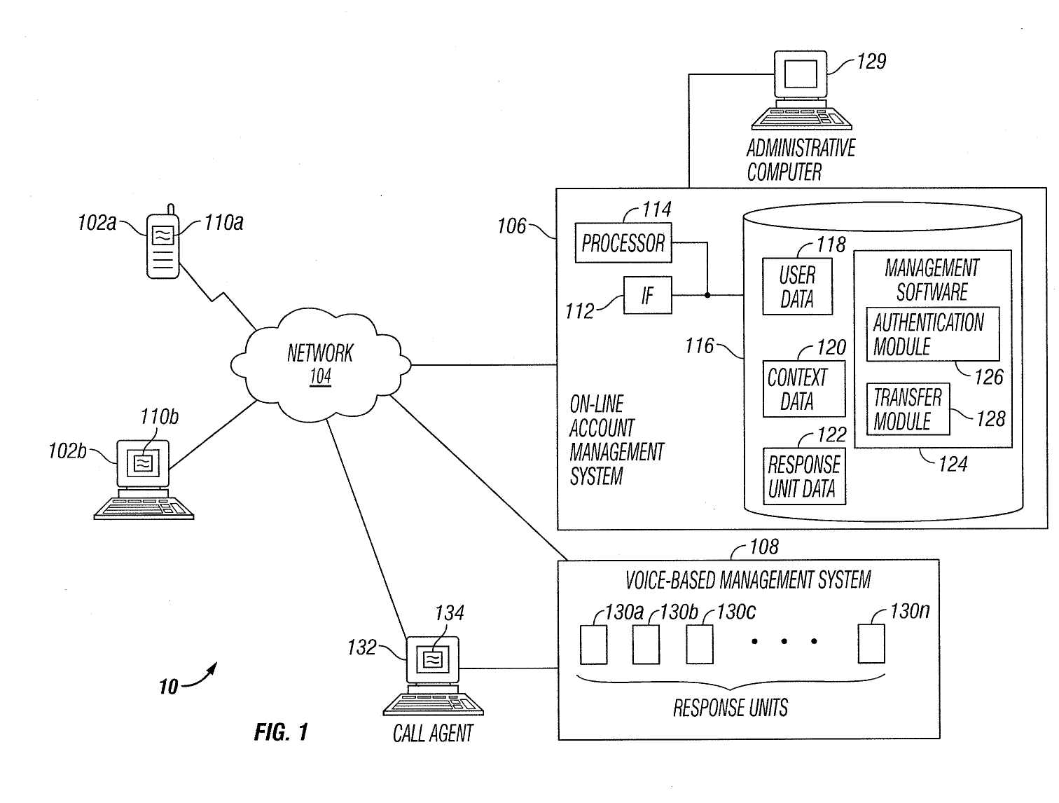

Embodiments of the present invention and its advantages are best understood by referring to FIGS. 1 through 3, like numerals being used for like and corresponding parts of the various drawings.

FIG. 1 illustrates a system 10 operable to facilitate communication with a voice-based management system. In particular embodiments, the user may access an on-line account management system through an access device using suitable access credentials. While navigating through the various interfaces of an on-line account management system, the user may have a question related to an attempted action related to an account. Through options presented on interfaces of the on-line account management system, the user may initiate a request for assistance. The user may be connected to a response unit in a voice-based management system, which may provide feedback on the user's request. A suitable response unit may be determined according to the type of user asking the question, the question's context or subject matter, and/or any other suitable criteria. The user may be authenticated to the response unit automatically without having to provide authentication credentials for a second time. Certain embodiments of system 10 include access devices 102 that communicate over network 104 with on-line account management system 106 and voice-based management system 108.

Devices 102 may comprise any type of mobile or stationary computing device operable to communicate and interact with on-line account management system 106, voice-based management system 108, and/or any other suitable system. In particular embodiments, devices 102 allow users to access accounts owned by the user and initiate actions associated with the accounts. Examples of devices 102 include a mobile phone, personal digital assistant, laptop, netbook, ultrabook, tablet, desktop computer, cable box, television, automobile, and/or any other suitable device.

Devices 102 include any necessary hardware and software suitable to carry out their functions. For example, devices 102 may include a processor for executing routines associated with receiving and requesting status information. A processor included in device 102 may comprise a programmable logic device, a microcontroller, a microprocessor, any suitable processing device, or any suitable combination of the preceding. Devices 102 may also include a memory comprising a non-transitory computer readable medium for storing software and data related to those software programs. Similarly, data may be input from a user and stored on device 102 in such a memory. Where appropriate, devices 102 may include a network interface to implement communication protocols to allow device 102 to communicate with the other components of system 10.

Devices 102 may include any suitable software to carry out its functions. For example, devices 102 may run any suitable operating system such as WINDOWS, MAC-OS, UNIX, LINUX, iOS, Windows Mobile, Android, and/or any other suitable operating system. Devices 102 may also include any suitable native applications, such as a web browser application, a messaging application, and/or a natively-installed client application specifically configured to work with one or more components of on-line account management system 106 and/or voice-based management system 108. A user of a device 102 may use an account manager application natively installed on device 102 to access and/or initiate actions associated with accounts under the control of on-line account management system 106.

Certain embodiments of system 10 include a device 102a that is a mobile phone, and a device 102b that is a desktop computer.

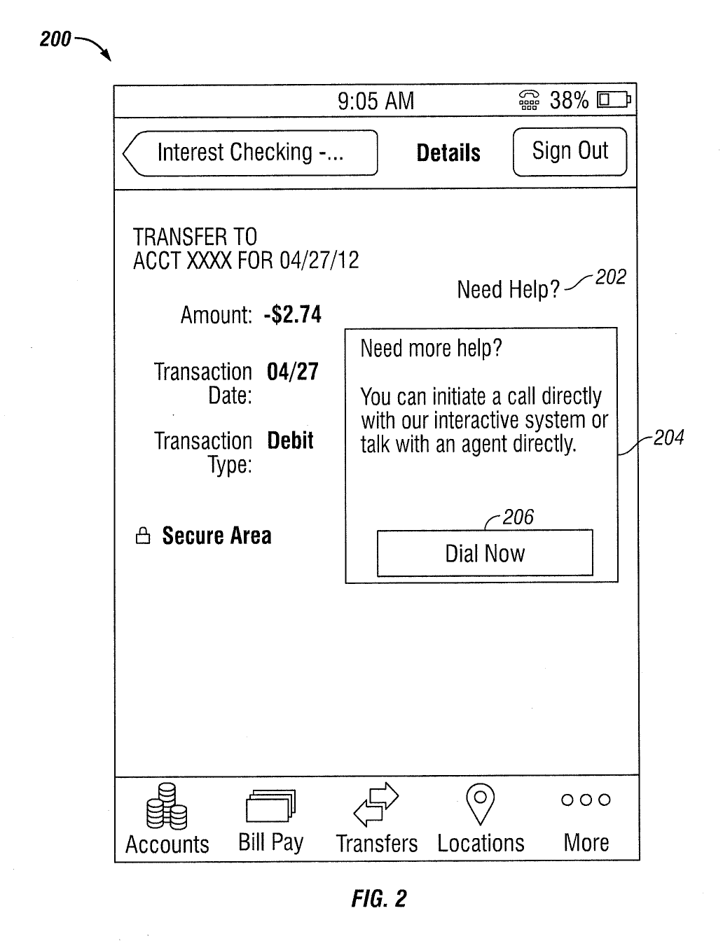

In certain embodiments, devices 102 include graphical user interfaces (“GUIs”) 110, which display information associated with one or more accounts owned by the user. GUIs 110 receive information from on-line account management system 106, from the user, and/or from any other suitable source. GUIs 110 are generally operable to tailor and filter data entered by and presented to the user. GUIs 110 may provide the user with an efficient and user-friendly presentation of information. For example, GUI 110a may display information associated with a user account and provide options for actions associated with the account. As non-limiting examples of this, GUI 110a may provide options for a user to transfer funds between accounts, make an on-line bill payment, add a new payee, display balance information, display transaction history, and/or any other suitable option. Additionally, GUIs 110 may provide users an option of connecting to voice-based management system 108 to answer questions regarding, for example, any of the actions available through GUI 110. Certain GUIs 110 may comprise a plurality of displays having interactive fields, pull-down lists, and buttons operated by the user. GUIs 110 may include multiple levels of abstraction including groupings and boundaries. It should be understood that the term GUI may be used in the singular or in the plural to describe one or more GUIs and each of the displays of a particular GUI 110. An example GUI 110 is described below with respect to FIG. 2.

GUIs 110 may be displayed to a user using a web browser that allows a user of access devices 102 to interact with a website, communicatively coupled to on-line account management system 106 for example, by transmitting information to and receiving information from the website. Suitable web browsers may include Microsoft Internet Explorer®, Mozilla Firefox®, Google Chrome™, Apple Safari™, or Opera®. In certain embodiments, GUIs 110 may be displayed using an application natively installed on each access device 102. For example, an enterprise associated with on-line account management system 106 and/or voice-based management system 108 may create and distribute an account management application designed for mobile phone device 102a and another account management application designed for computer 102b that both operate outside of a web browser. A user may install the account management application on an access device and interact with the GUI provided by the account management application to communicate with and instruct on-line account management system 106 to perform certain actions. In certain embodiments, GUIs 110 may be provided by a website or native application maintained by a third-party.

Network 104 represents any suitable network that facilitates communication between the components of system 10. Network 104 may include any interconnecting system capable of transmitting audio, video, signals, data, messages, or any combination of the preceding. Network 104 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

On-line account management system 106 includes any suitable combination of components that facilitate communication with devices 102 and allow users of those devices to attempt to perform certain actions associated with one or more accounts. In particular embodiments, on-line account management system 106 is operable to determine a response unit in voice-based management system 108 suitable for providing feedback to questions submitted by a user of a device 102. On-line account management system 106 may include the computing systems controlled by a financial institution, such as a bank, brokerage house, or investment firm. The accounts that on-line account management system 106 controls may be any suitable account. For example, on-line account management system 106 may have direct control over a checking account, a savings account, a brokerage account, a loan account, an investment account, a retirement account, an education savings account, and/or any other suitable account.

On-line account management system 106 may include a network server, any suitable remote server, a mainframe, a host computer, a workstation, a web server, a personal computer, a file, server, or any other suitable device operable to facilitate communicating with devices 102 and processing requests received from devices 102. In some embodiments, on-line account management system 106 may execute any suitable operating system such as IBM's zSeries/Operating system (z/OS), MS-DOS, PC-DOS, MAC-OS, WINDOWS, UNIX, OPenVMS, Linux, iOS, Android, and/or any other appropriate operating systems, including operating systems developed in the future. The functions of on-line account management system 106 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, on-line account management system 106 includes a network interface 112, a processor 114, and a memory 116.

Network interface 112 represents any suitable device operable to receive information from network 104, perform suitable processing of the information, communicate to other devices, or any combination of the preceding. For example, network interface 112 may receive requests for processing certain account actions and/or for more information from a user of device 102a via network 104. Network interface 112 represents any port or connection, real or virtual, including any suitable hardware and/or software, including protocol conversion and data processing capabilities, to communicate through a LAN, WAN, or other communication systems that allows on-line account management system 106 to exchange information with the other components of system 10.

Processor 114 communicatively couples to network interface 112 and memory 116. Processor 114 controls the operation and administration of on-line account management system 106 by processing information received from network interface 112 and memory 116. Processor 114 includes any hardware and/or software that operates to control and process information. For example, processor 114 executes management software 124 to control the operation of on-line account management system 106. Processor 114 may be a programmable logic device, a microcontroller, a microprocessor, any suitable processing device, or any suitable combination of the preceding.

Memory 116 stores, either permanently or temporarily, data, operational software, rules, or other information for processor 114. Memory 116 includes any one or a combination of volatile or nonvolatile local or remote devices suitable for storing information, such as a non-transitory computer readable storage medium. For example, memory 116 may include random access memory (RAM), read only memory (ROM), magnetic storage devices, optical storage devices, or any other suitable information storage device or a combination of these devices. While illustrated as including particular modules, memory 116 may include any suitable information for use in the operation of on-line account management system 106.

In certain embodiments, memory 116 includes user data 118, context data 120, response unit data 122, and management software 124.

User data 118 includes any rules and/or data associated with users of on-line account management system 106. For example, user data 118 may include identifying information such as a user's name, date of birth, address, phone number, and/or any other suitable identifying information. User data 118 may also include information related to a user's accounts such as account numbers, nicknames for accounts, account identifiers associated with an account, balance information of an account, limits of an account, user preferences, any other suitable data, or any suitable combination of the preceding.

User data 118 may also specify a user type associated with a user and/or information from which a user type may be derived. For example, user data 118 may include a table or other data structure that associates a user with a designated type. In certain embodiments, users may be designated as standard and/or preferred. A user may be designated as preferred, for example, if the total amount of funds the user has in an account managed by an institution associated with on-line account management system 106 exceeds a certain threshold. A user may also be designated as “preferred” if, for example, the user has owned an account for a period of time that exceeds a certain threshold, if the user has multiple accounts, the user is associated with a preferred supplier, the number of times that the user has overdrawn an account is below a certain threshold, and/or any other suitable criteria.

As another example of user type designations, a user may be classified into user types according to the type of account that the user has with an institution associated with on-line account management system 106. Non-limiting examples of these user types include checking account owner, credit card account owner, investment account owner, loan account owner, and/or any other suitable category associated with possible accounts owned by a user.

As another example of user type designations, a user may be classified into user types according to a level of risk associated with the user. For example, risk-related user types may include low risk user, medium risk user, and high risk user. A user may be designated as a high risk user if, for example, at the time the user uses access device 102 to communicate with on-line account management system 106, the user's account has been open for 48 hours or less. As another example, a user may be designated as a high risk user if the user is associated with a minimum number of failed attempts to log on to on-line account management system 102. Any other suitable criteria may be used to designate a user as high risk. A user may be designated as a medium risk user if, for example, the user has recently logged on from a new access device 102 distinct from a previous access device 102 used to access on-line account management system 106. As another example, a user may be designated as medium risk user if, for example, the user's account has been open for more than 48 hours but less than or 30 days. Any other suitable criteria may be used to designate a user as medium risk. A user may be designated as low risk if, for example, the user is not designated as high risk or medium risk. Any other suitable criteria may be used to designate a user as low risk.

Context data 120 includes any rules and/or data associated with the subject matter of the questions that may be submitted by users of on-line account management system 106. For example, in certain embodiments, context data 120 stores each question that a user is capable of submitting over the graphical user interface of a device 102. The stored questions may be associated with a suitable context in a look-up table or other data structure in context data 120. As another example, context data 120 may store sites from which the user question is submitted and store an association between the site and a context. For example, a user may initiate a request for a question from a certain web page accessible through on-line account management system 106, such as a transaction history page. Context data 120 may store an association between the particular web page and a context.

Non-limiting examples of contexts include prior transactions, on-line bill payment, payment card inquiries, on-line account management system preferences/access, and/or any other suitable context. A prior transactions context may be associated, for example, with questions that relate to previous payment transactions associated with a user's account. An on-line bill payment context may be associated, for example, with questions that relate to using a feature of on-line management account system 106 that allows a user pay bills using on-line management account system 106 and graphical user interface 110 of a device 102. A payment card inquiries context may be associated, for example, with questions that relate to use of debit, ATM, and/or any other suitable payment card. An on-line account management system preferences/access context may be associated, for example, with questions that relate to the devices 102 allowed to access an account using on-line account management system 106, allowing additional users to access an account via on-line account management system 106, and/or any other suitable question related to user preferences/access. In certain embodiments, a user may be able enter a customized question on graphical user interface 110. Such a custom question may be associated with, for example, a general context, custom context, and/or any other suitable context.

Response unit data 122 includes any rules and/or data used to associate questions that may be submitted by users with a particular response unit. For example, response unit data 122 may have a rule that indicates that a question associated with the prior transactions context should be submitted to a prior transactions response unit. If, for example, the user is associated with a “standard” user type, a rule in response unit data 122 may indicate that the question should be routed to an interactive voice response “IVR” response unit configured to answer questions associated with the “prior transactions” context. If, however, the user is associated with a “preferred” user type, a rule in response unit data 122 may indicate that the question should be handled by a response unit that facilitates communication between the user and a human call agent. As another example, a rule in response unit data 122 may indicate that a user associated with a “high” or “medium” fraud risk should always be routed to a response unit capable of evaluating fraud possibilities for all question contexts. Alternatively, a rule in response unit data 122 may indicate that a user should be routed to a fraud response unit if the question context relates to certain attempted actions that may result in misappropriation of funds, such as, for example, bill payment and/or wire transfers. Response unit data 122 may use any combination of user type, context, and/or any other suitable criteria in specifying a response unit for a question submitted by a user.

Management software 124 represents any suitable set of instructions, logic, or code embodied in a non-transitory, computer readable medium and operable to facilitate the operation of on-line account management system 106. Management software 124 may include, for example, modules operable to facilitate peer-to-peer transfers from one user's account to another user's account, check for balance information, facilitate on-line bill payment, facilitate selection and/or addition of new payees, create new accounts, initiate wire transfers, authenticate user to the on-line account management system 106, transfer users to other systems, and/or any other suitable modules. Certain embodiments of management software 124 include an authentication module 126 and a transfer module 128.

Authentication module 126 includes any suitable logic operable to determine whether a user should gain access to an account using on-line management system 106. For example, a user may provide authentication credentials to on-line management system 106 using GUI 110. Such credentials may include a username, password, account identifier, access device identifier, and/or any other information suitable to form a basis as to whether a user should gain access to on-line account management system 106. As additional examples, authentication credentials may take the form of a facial feature, voice, and/or other biometric data taken with a camera or other input device provided on device 102.

Authentication module 126 may instruct processor 114 to retrieve information stored in user data 118 associated with a user and/or account. Processor 114 may compare the stored values with the values provided by the user through GUI 110 in order to determine whether the user should be permitted access. If the credentials provided the user through GUI 110 are not correct, authentication module 126 may include instructions for the user to make additional attempts to provide suitable credentials for gaining access to on-line account management system 106. For users that provide suitable credentials for gaining access to on-line account management system 106, authentication module 126 may specify that the credentials provided by the user be stored in user data 118. These may be used if, for example, during the user's session with on-line management system 106, the user initiates an attempt to be connected to a response unit in voice-based management system 108. Alternatively, instead of storing the credentials provided by the user over GUI 110, authentication module 126 may specify that a flag be set in user data 118 that indicates that the user has successfully gained access to on-line account management system 106. Such a flag may expire after a certain amount of time and/or when a user ends a session using on-line account management system 106. This flag may be checked if, for example, the user initiates an attempt to be connected to a response unit in voice-based management system 108.

Transfer module 128 includes any suitable logic operable to connect a user to a response unit in voice-based management system 108. For example, when an authenticated user attempts to connect to voice-based management system 106, transfer module 128 may specify that user type should be retrieved from user data 118. Alternatively, transfer module 128 may specify that information should be collected from user data 118 from which a user type may be derived. Transfer module 128 then may determine the appropriate user type. Additionally, transfer module 128 may specify that a question context should be collected from context data 120 based on the question submitted by the user. Once transfer module 128 has instructed processor 114 to determine the user type, question context, and/or any other suitable criteria, transfer module 128 may specify that response unit data 122 be accessed to determine a suitable response unit for the question submitted by the user. Instead of having the user go through another authentication process, transfer module 128 may authenticate the user to a response unit in voice-based management system 108 by using the session credential provided by the user at the beginning of the user's session with on-line account management system 106, checking a flag in user data 118 indicating an active/authenticated session with on-line account management system 106, and/or in any other suitable manner. In certain embodiments, the user's session with on-line account management system 106 may remain active while the user is connected to a response unit in voice based management system 108.

Administrative computer 129 represents any suitable components that facilitate establishment and/or modification of the configuration of any of the components of on-line account management system 106. An administrator may use administrative computer 129 to update the rules in user data 118, context data 120, and response unit data 122. For example, an administrator may determine the criteria that indicate what users are associated with a certain user type. The administrator may store these directly in user data 118 and/or enable management software 124 to use this criteria to determine user type. Likewise, an administrator may select the questions that may be submitted by users while the users navigate GUI 110. The administrator may group these questions into question contexts and create/update context data 120 as appropriate. Additionally, an administrator may determine which response units should be used for particular combinations of user types, contexts, and/or any other suitable criteria. The administrator may create/update response unit data 122 as appropriate.

Administrative computer 129 may comprise a network server, any suitable remote server, a mainframe, a host computer, a workstation, a web server, a personal computer, a file, server, or any other suitable device operable to configure the components and rules used by on-line account management system 106. In some embodiments, administrative computer 129 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 129 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

Voice-based management system 108 represents any suitable components operable to provide responses to questions submitted by a user through on-line account management system 106. Voice-based management system 108 may have modules and functionality that allow a user to manage an account similar to on-line account management system 106. Voice-based management system 108 includes a plurality of response units 130, each designated to handle questions submitted by certain users. For example, response unit 130a and response unit 130b may both be configured to handle questions related to a “prior transactions” context. In certain embodiments, response unit 130a may be an IVR unit while response unit 130b may facilitate connecting the user to a human-operated call agent 132. As another example, response unit 130a and 130b may be similar to one another such that multiple units are able to handle calls from several different users and/or act as a secondary response unit 130 if a primary response unit 130 fails for some reason. Additionally, response unit 130c may be the response unit designated to respond to the users associated with a medium and/or high fraud risk. Response unit 130c may be an IVR unit and/or a unit operable to facilitate connecting the user to a call agent 132. Call agent 132 may have a graphical user interface 134 suitable to automatically show an operator the question submitted by the user when the connection with the user is made. Call agent 132 may assist the user directly to complete whatever action the user was attempting to complete.

In certain embodiments, users may be able to connect directly to voice-based management system 108 without using on-line account management system. In such a situation, the user may provide all of the user's authentication's information for verification by the voice-based management system 108. The user may also provide a question orally, which may be less precise and/or contain less information compared to when the question is routed through on-line account management system 106. Using on-line account management system 106 to facilitate providing the question response may reduce the overall time the user spends in authentication and/or presenting the question that needs a response.

Voice-based management system 108, response units 130, and/or call agent 132 may comprise a network server, any suitable remote server, a mainframe, a host computer, a workstation, a web server, a personal computer, a file, server, or any other suitable device operable to provide responses to questions submitted by users of devices 102. In some embodiments, voice-based management system 108, response units 130, and/or call agent 132 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of voice-based management system 108, response units 130, and/or call agent 132 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In an example embodiment of operation of system 10, a user uses GUI 110a of mobile phone 102a to access on-line account management system 106. The user enters a username and password as access credentials. Management software 124 determines that the user has suitable credentials and allows the user access to on-line account management system 106 to manage a specific account. The user navigates to the on-line bill payment section on GUI 110. The user attempts to add a new payee in order to pay a bill on-line but has a question regarding the payee addition/selection feature of the on-line bill payment module. The user selects a control on GUI 110 to submit a question through on-line account management system 108. On-line account management system 106 determines that the user is associated with a “preferred” user type. On-line account management system 106 does this by determining the user has a total amount of funds saved with the entity associated with on-line account management system 106 that exceeds a predetermined threshold. On-line account management system 106 determines that the user should be connected with response unit 130b because response unit 130b handles questions in the on-line bill payment context submitted by preferred users in the on-line bill payment context. The user interacts with a voice provided through response unit 130b using the voice functions that mobile phone 102a. The user continues to navigate GUI 110 during and/or after connecting with response unit 130b.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, management software 124 may include logic for choosing between several response units 130 operable to provide responses to a question. For instance, response unit 130a may be able to provide responses to questions related to contexts A, B, and C. Response unit 130b may be able to provide responses to questions related to contexts B, C, and D. Response unit 130c may be able to provide response to questions related to contexts C, D, and F. For a question submitted that relates to context B, on-line account management system 106 may choose response unit 130a or response unit 130b. This selection may depend on the current load on these response units, proximity to the user, and/or any other suitable criteria. As another example, a user that will ultimately be routed to a call agent 132 may begin by connecting to an IVR response unit and vice versa. Furthermore, the components of system 10 may be integrated or separated. For example, voice-based management system 108 may be incorporated into on-line account management system 106.

FIG. 2 illustrates an example GUI 200 operable to allow a user to submit a question regarding a prior transaction. In certain embodiments, GUI 200 may be an example of GUI 110a that appears on mobile phone 102a of FIG. 1. GUI 200 indicates that, on Apr. 27, 2012, a transfer was made from the user's account to an account with identifier XXXX. The transfer amount was $2.74. In certain embodiments, this amount may be associated with a bank transfer program, where the difference between a transaction amount and the next highest dollar amount is transferred to a specified different account. In certain embodiments, the amount transferred, such as “$2.74,” may be the sum of all such differences on transactions for a specified time period.

If the user has a question about this transaction, in particular embodiments, the user may click on a “need help” link 202, which brings up a box 204. The user may then select a “dial now” button 206 to attempt to connect to a voice-based management system. In certain embodiments, the site or location within a GUI may be submitted with the request in order for a question context to be derived. The user may not have to provide authentication credentials in order to be authenticated to the voice-based management system. In certain embodiments, the entire screenshot of GUI 200 may be provided to a response unit selected to provide voice feedback to the user.

Modifications, additions, or omissions may be made to GUI 200 without departing from the scope of the invention. For example, box 204 may provide a text entry field for a user to submit a customized question. Such a customized question does not have to be related to the page of GUI 200 that the user is currently interacting with. Additionally, the option to connect to a voice-based management system may exist on any suitable screen of GUI 200, which may relate to any suitable context.

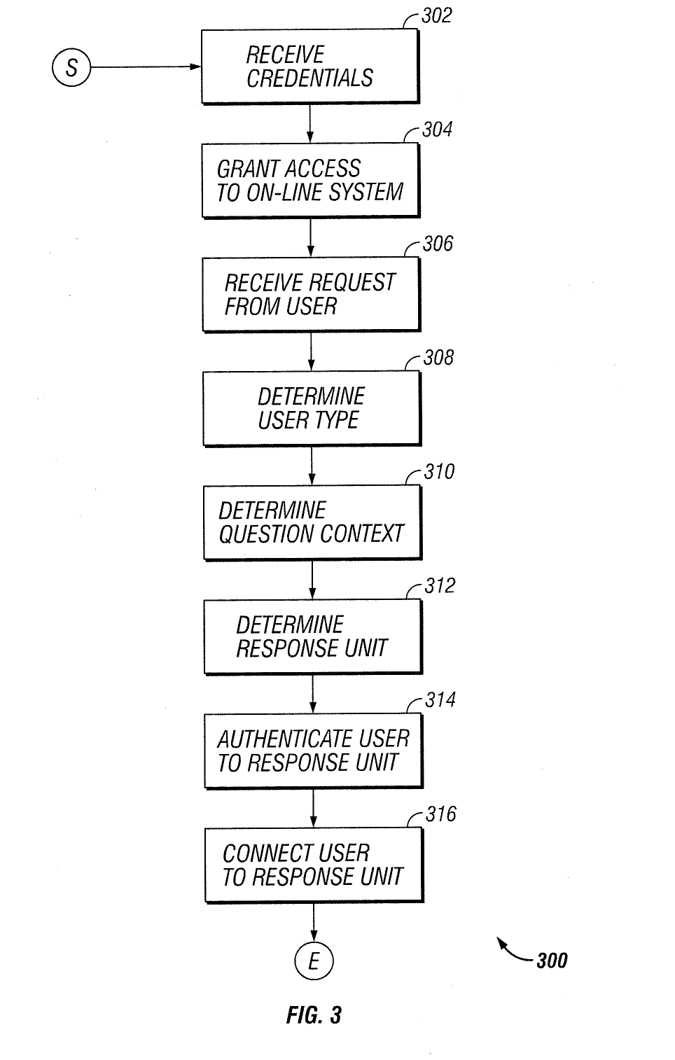

FIG. 3 illustrates an example method 300 for facilitating communication with a voice-based management system. The method begins at step 302, where authentication credentials are received. These may be provided by a user using a GUI on an access device, such as a mobile phone or a computer. At step 304, access is granted to an on-line account management system after a check is done to see if the credentials are appropriate. The user may be identified by analyzing the authentication credentials and comparing the credentials stored in user data. The user may be allowed to take actions associated with a user account. At step 306, a request is received from a user to connect to a voice-based management system. The request may include a question and/or information related to the site or location in the GUI from which the request is made. At step 308, a user type may be determined by accessing information stored in user data. In certain embodiments, the user type may depend on a level of funds that user has in one or more accounts, whether the user is associated with a certain risk level of fraud, and/or any other suitable criteria. At step 310, a context is determined for the information or question provided in the request to connect to a voice-based management system. The context may be determined by analyzing the subject matter in the question, the information related to the site or location in the GUI from which the request is made, and/or any other suitable criteria.

At step 312, a suitable response unit is determined. The response unit may be determined according to the user type determined in step 308, the context determined in step 310, and/or any other suitable criteria. The response unit may be operable to provide a response to the question included in the request. The response unit may be an IVR response unit and/or a response unit able to facilitate voice communication between the user and a human agent. The user is authenticated to the determined response unit at step 314. The credentials provided by the user to log on to the on-line account management system may be used together with any other suitable information to authenticate the user to the response unit. The user is connected to the response unit at step 316. The user may not need to provide any additional log-on credentials when the connection is made to the response unit.

Modifications, additions, or omissions may be made to method 300 disclosed herein without departing from the scope of the invention. The methods may include more, fewer, or other steps. For example, in step 314, the authentication credential may not need to be provided to the response unit. Rather, when the request is routed through a trusted on-line account management system that has already authenticated a user, the response unit may not need to verify information, such as a password. Additionally, steps may be performed in parallel or in any suitable order. For example, steps 308 and 310 may be performed in reverse or in parallel.

Certain embodiments of the invention may provide one or more technical advantages. A technical advantage of one embodiment allows a user to be authenticated to a voice-based management system automatically from within an on-line account management system. The user may not have to go through additional validation/authentication steps when connecting to the voice-based management system. Another technical advantage of an embodiment allows the user to submit a question through a graphical user interface of an on-line account management system. Information about the question and the user may be routed to a suitable response unit with minimum reproduction of the same input provided by the user. This may reduce the amount of time the user spends overall attempting to get an answer to a question. The overall time spent may be reduced even further if the user otherwise would have been routed through several different response units in order to have a question answered suitably, each time requiring user validation/authentication.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An on-line account management system for facilitating communication with a voice-based management system, comprising:
a memory comprising rules associated with facilitating communication with a voice-based management system; and
a processor communicatively coupled to the memory and operable to:
receive an authentication credential;
based on the authentication credential, allow a user to access an on-line management system operable to facilitate management of an account;
receive, by the on-line management system, a request to connect the user to the voice-based management system operable to facilitate providing a response to a question included in the request;
determine a user type associated with the user;
determine a context associated with the question included in the request;
determine a response unit in the voice-based management system according to the user type and the context; and
connect the user to the response unit in the voice-based management system without requiring the user to provide the authentication credential to the response unit.

2. The system of claim 1, wherein the processor is further operable to authenticate the user to the response unit in the voice-based management system using the authentication credential.

3. The system of claim 1, wherein the processor is further operable to determine the user type by determining a level of funds that the user has in the account.

4. The system of claim 1, wherein the processor is further operable to determine the user type by determining a fraud risk associated with the user.

5. The system of claim 1, wherein the processor is further operable to determine the context by determining a site in the on-line management system from which the request is made.

6. The system of claim 1, wherein the response unit is one of a group consisting of an interactive voice response module and a contact center module operable to facilitate voice communication with a human agent.

7. The system of claim 1, wherein the response unit is a contact center module operable to facilitate voice communication with a human agent, wherein the processor is further operable to automatically provide the question to a device operated by the human agent.

8. A method for facilitating communication with a voice-based management system, comprising:
receiving an authentication credential;
based on the authentication credential, allowing a user to access an on-line management system operable to facilitate management of an account;
receiving, by the on-line management system, a request to connect the user to a voice-based management system operable to facilitate providing a response to a question included in the request;
determining, using a processor, a user type associated with the user;
determining, using the processor, a context associated with the question included in the request;
determining, using the processor, a response unit in the voice-based management system according to the user type and the context; and
connecting the user to the response unit in the voice-based management system without requiring the user to provide the authentication credential to the response unit.

9. The method of claim 8, further comprising authenticating the user to the response unit in the voice-based management system using the authentication credential.

10. The method of claim 8, wherein determining the user type comprises determining a level of funds that the user has in the account.

11. The method of claim 8, wherein determining the user type comprises determining a fraud risk associated with the user.

12. The method of claim 8, wherein determining the context comprises determining a site in the on-line management system from which the request is made.

13. The method of claim 8, wherein the response unit is one of a group consisting of an interactive voice response module and a contact center module operable to facilitate voice communication with a human agent.

14. The method of claim 8, wherein the response unit is a contact center module operable to facilitate voice communication with a human agent, the method further comprising automatically providing the question to a device operated by the human agent.

15. A non-transitory computer readable medium comprising logic, the logic when executed by a processor, operable to:
receive an authentication credential;
based on the authentication credential, allow a user to access an on-line management system operable to facilitate management of an account;
receive, by the on-line management system, a request to connect the user to a voice-based management system operable to facilitate providing a response to a question included in the request;
determine a user type associated with the user;
determine a context associated with the question included in the request;
determine a response unit in the voice-based management system according to the user type and the context; and
connect the user to the response unit in the voice-based management system without requiring the user to provide the authentication credential to the response unit.

16. The computer readable medium of claim 15, wherein the logic is further operable to authenticate the user to the response unit in the voice-based management system using the authentication credential.

17. The computer readable medium of claim 15, wherein the logic is further operable to determine the user type by determining a level of funds that the user has in the account.

18. The computer readable medium of claim 15, wherein the logic is further operable to determine the context by determining a site in the on-line management system from which the request is made.

19. The computer readable medium of claim 15, wherein the response unit is one of a group consisting of an interactive voice response module and a contact center module operable to facilitate voice communication with a human agent.

20. The computer readable medium of claim 15, wherein the response unit is a contact center module operable to facilitate voice communication with a human agent, wherein the processor is further operable to automatically provide the question to a device operated by the human agent.
